(19) United States
(12) Patent Application Publication
(10) Pub. No.: US 2005/0228732 A1
(43) Pub. Date: Oct. 13, 2005

(54) Perpetual funding method for mitigating impacts on public infrastructure projects

(75) Inventors: Ronn T. Slay, Atwater, CA (US); Nello Ferretti, Los Banos, CA (US); Earle Cummings, Geyserville, CA (US); Mark Gregory, Merced, CA (US)

Correspondence Address: MARK D MILLER;KIMBLE, MACMICHAEL & UPTON, 5260 NORTH PALM AVENUE, SUITE 221, FRESNO, CA, 93704, US

(73) Assignee: California Natural Resources Foundation

(21) Appl. No.: 11/100,288

(22) Filed: Apr. 5, 2005

Related U.S. Application Data
(60) Provisional application No. 60/560,404, filed on Apr. 8, 2004.

(51) Int. Cl. G06F 17/60

(52) U.S. Cl. 705/35

(57) ABSTRACT

The present invention generally provides a method for administering project finding, whereby the project administrator receives an endowment or startup grant from a sponsoring entity, and utilizes said endowment or grant to purchase financial instruments offered by that entity. This creates a zero net loss situation for the sponsoring entity. In return, the project administrator receives the income generated by the financial instruments, and pays the project expenses from such income without invading the endowment or startup grant.

This application claims the benefit of U.S. Provisional Application No. 60/560,404, filed on Apr. 8, 2004, which is incorporated herein by this reference.

### BACKGROUND OF THE INVENTION

1. Field of the Invention

The present invention relates to methods for preserving mitigation endowments set aside from public infrastructure projects, and more particularly, to a method for returning such endowments to the government through investments in appropriate financial instruments.

2. Description of the Prior Art

Many state and federal statutes require government agencies to mitigate the environmental impacts of new infrastructure projects upon local wildlife habitats, archeological sites, spiritual sites or natural resources. The particular mitigation requirement depends upon the acreage and value of the land impacted by the particular public project. The amount and type of mitigation necessary to satisfy such requirement depends upon the particular characteristics of the mitigation. For example, a general wildlife habitat may only be worth a nominal number of credits per acre. Particular or especially valuable types of wildlife habitat, such as wetlands, or ones designed for certain endangered species, are worth a greater number of credits per acre. The total number of credits of the habitat must equal or exceed the mitigation requirement of the particular public project.

Mitigation banks can be, and have also been, used for the preservation of archeological sites and artifacts, spiritual sites, and sites particularly suited for the cultivation of natural materials (such as medicinal herbs or basket weaving materials).

Locating the land, determining the optimal combination of characteristics to satisfy the mitigation requirement, and developing and maintaining the mitigation bank is a complicated and time-consuming process. Certain monies must be set aside from the public infrastructure project as endowments to develop, maintain and administer the mitigation banks. Many “land banking” companies prepare properties for such purposes. These companies acquire undeveloped or underdeveloped property from third-party landowners, either by purchasing the property outright or entering into long-term or perpetual leases with the landowners, and hold the property until it is ready to be developed. Unfortunately, many land banking companies do not carefully administer the endowment. Instead, they deplete the endowment with high development and administrative fees and costs. This leaves little money to maintain the habitat for any length of time, much less perpetually. Once the endowment is exhausted, the habitat is generally ignored by the company and left to fall into disrepair. Alternatively, and commonly, the company may transfer the habitat to a state or federal agency responsible for habitat management, thereby creating a significant burden upon taxpayers.

For example, a project may have a mitigation requirement of one hundred credits, and require one million dollars to be set aside to develop, maintain and administer the habitat. A land banking company may incur approximately seven thousand dollars per acre to establish a general habitat worth one credit per acre. This results in a development cost of seven hundred thousand dollars. Annual maintenance and administrative costs may equal thirty thousand dollars per year. Discounting a minimal rate of investment return upon the remaining endowment corpus (assuming that the land banking company invests the endowment in some form of revenue-generating instruments), the endowment would be depleted in approximately ten years, leaving the land to fall into disrepair after that time.

At that time, the mitigation bank may be transferred to a state or federal habitat management agency, such as the United States Fish and Wildlife Service or the California Department of Fish and Game, shifting the burden onto the taxpayers. Accumulations of projects with depleted endowments will have a significant effect upon the government's ability to fund additional public infrastructure projects, or any projects at all.

Furthermore, the government agencies charged with monitoring the development, maintenance and administration of mitigation banks generally do not have the resources to do so beyond completion of the public project. Such agencies may lack the time and/or resources necessary to regularly update and maintain information concerning the particular species supported by a habitat, or may find itself having to convert existing habitats to support popular species, thereby displacing the former supported species. Thus, such agencies may not be particularly suited to maintaining the endowment fund and habitat.

Finally, a site selected as a mitigation bank may be, or may subsequently become, unsuitable for its original intended purpose. For example, a site initially selected to mitigate for traditional willow root and willow root sedge used in native basket-weaving may become unsuitable if the site is no longer flooded (i.e., if a dam is constructed across the upstream water source). A land banking company or government agency must perpetually monitor site conditions to ensure that the site remains properly suited for its task. Furthermore, the company or agency must have perpetual funding means to ensure that any adverse changes to the site conditions are corrected or mitigated as soon as possible. Such close monitoring is difficult or impossible with the current method of financing and maintaining mitigation properties.

A second major concern of public infrastructure projects is the limited availability of funds for such projects. Infrastructure funding must compete with the myriad of other expenses of local, state and federal governments. Recent increases in those other expenses have decreased the amount of money available to initiate new public infrastructure projects, or maintain existing ones. Given the mitigation requirements of the infrastructure projects, and the monetary costs associated therewith, money spent upon mitigation is money that is unavailable for the infrastructure projects themselves. Various business methods have been developed for long-term funded and/or self-sustaining projects. For example, U.S. Publication Nos. 2003/0023467 and 2002/0116211 both disclose methods whereby the principal amounts are invested, and the interest income and/or investment profits used to pay operating expenses. Such business methods thereby potentially minimize the rate of invasion upon the principal. Unfortunately, such methods are not wholly applicable to the area of infrastructure project mitigation. Specifically, they do not address the second major concern of funding mitigation endowments—the depletion and resulting unavailability of public funds for future projects. Instead, the methods disclosed in both applications require transfer of the principal from the budgets of the funding sources to the third-party recipient entities. As applied to the area of public infrastructure mitigation, this essentially means that the government loses access to the monies upon such payment. Since governments do not have unlimited budgets for public infrastructure projects, such loss means that future infrastructure projects may not receive sufficient funding.

Furthermore, although the 2003/0023467 publication discloses the return of the initial investment principal to the funding source once the business model becomes self-sustaining, such return may not occur for a long period of time, if at all. Thus, even if a land banking company is able to invest the endowment so as to pay all operating expenses from the interest income and/or investment profits, the government is still deprived of the infrastructure funds for a certain period of time. During that period of time, fewer funds are available for other infrastructure projects.

It is therefore desirable to provide a method for preserving mitigation endowments set aside from public infrastructure projects. It is further desirable that such a method minimizes and/or prevents any invasion or depletion of the endowment. It is further desirable that such a method allow the mitigation habitat to be funded perpetually so as not to require any additional taxpayer dollars for maintenance and/or administration. It is further desirable that the endowment remain sufficiently sizeable so as to accommodate emergencies and/or unexpected expenses. Finally, it is desirable that the method return the endowment to the government for use on subsequent infrastructure projects, or other projects.

### SUMMARY OF THE INVENTION

The present invention provides a method for investing mitigation endowments in a manner that minimizes the invasion and/or depletion of the endowment, while returning said endowment to the sponsoring government (the government whose agency originates the infrastructure project) for subsequent use on other projects.

Essentially, once an infrastructure project is designated by state or federal statutes as having mitigable environmental impacts, the originating agency and/or project contractor retains a land banking company to locate suitable real property, develop it into a wildlife habitat, and maintain it for perpetuity. For such purposes, the originating agency and/or project contractor also provides the land banking company with an endowment set aside from the infrastructure project.

The land banking company invests the endowment in available, secure and appropriate financial instruments offered by the sponsoring government. This essentially returns the endowment to the sponsoring government's general treasury, resulting in a zero net loss to the government and allowing the government to utilize the endowment amount in subsequent infrastructure projects, or any other projects the government wishes to find. If the sponsoring government does not offer any financial instruments, the endowment may be invested in instruments offered by other governments, or in instruments offered by private entities.

The land banking company receives the interest and/or profits earned by the investments. Such income is used to develop the habitat and pay its expenses. Because the expenses are paid from the income, and not the endowment itself, the present invention minimizes any invasion or depletion of the endowment. Upon maturity of the financial instruments, the endowment is “rolled over” or invested in the same, similar, or other suitable instruments offered by the sponsoring government. A portion of the money may also be used for other projects, as designated by the land banking company and/or sponsoring government. This ensures that the sponsoring government is never deprived of the endowment amount. Instead, the only money ever removed from the sponsoring government's treasury is the interest and/or profits it pays to the land banking company as holder of the financial instruments. This is the same money that the sponsoring government would pay to any other holder of a government-offered financial instrument.

It is therefore a primary objective of the present invention to provide a method for preserving mitigation endowments set aside from public infrastructure projects.

It is another primary objective of the present invention that such a method minimizes and/or prevents any invasion or depletion of the endowment.

It is another primary objective of the present invention that such a method returns the endowment amount to the sponsoring government for use on subsequent projects.

It is another objective of the present invention that such a method allow the mitigation bank to be funded perpetually so as not to require any additional taxpayer dollars for maintenance or administration.

It is another objective of the present invention that such a method allows the endowment to remain sufficiently sizeable so as to accommodate emergencies and/or unexpected expenses.

Additional objects of the invention will be apparent from the detailed description and the claims herein.

### BRIEF DESCRIPTION OF THE DRAWINGS

FIG. 1. is a flowchart depicting a particular embodiment of the present invention.

FIG. 2. is a spreadsheet comprising sample capital improvement costs for developing a wetland restoration project.

FIG. 3. is a spreadsheet depicting a sample pro form a budget for a wetland restoration project administered according to the present invention.

### DETAILED DESCRIPTION

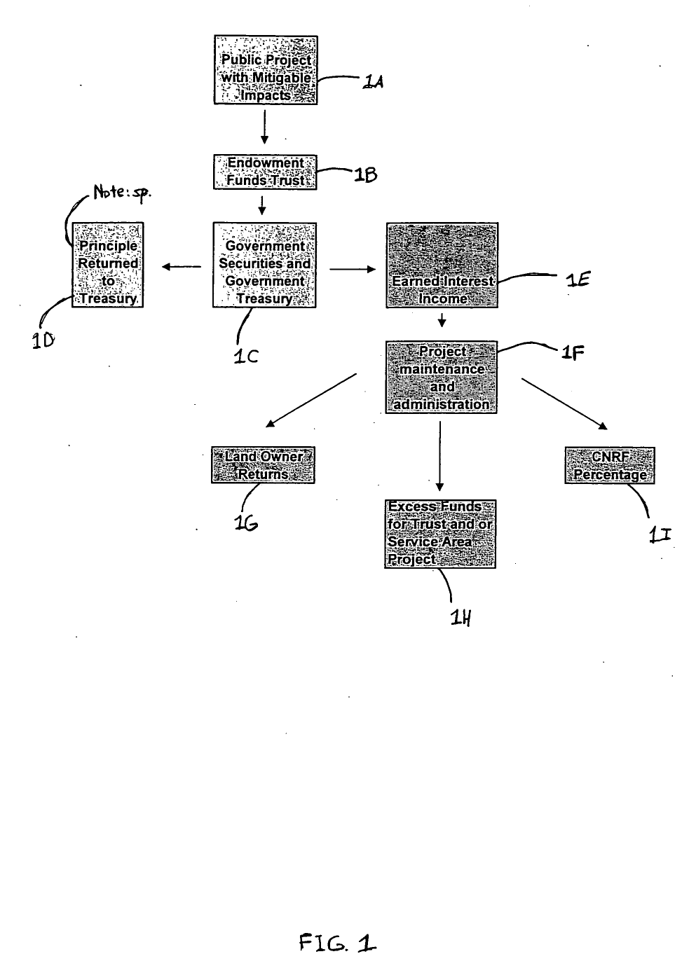

Referring particularly to FIG. 1, it is seen that the present invention is a method for managing endowments so as to protect them from routine depletion or invasion, and to return the endowment principal to the sponsoring government for subsequent use.

First, a public infrastructure project may be designated by state or federal statues as having mitigable environmental impacts. (Step 1A.) Such a designation requires the originating government agency to mitigate the adverse environmental impacts of the project. The particular mitigation requirement—usually a certain number of acres that must be dedicated for wildlife habitats to offset the adverse environmental effects of the project—is calculated according to any number of methods. The originating agency may retain the obligation of satisfying the requirement, or in most instances, pass the obligation along to the project contractor.

The originating agency or project contractor may retain a land banking company to locate suitable real property, develop it into a wildlife habitat, and maintain it for perpetuity. This land banking company may be any public or private entity, including entities that currently provide such services. The fees charged by the company may be any appropriate amount or percentage. The company is provided a mitigation endowment, usually set aside from the project contract price, for such purposes. (Step 1B.) Such amount may be, but is not required to be, held by the company in perpetual trust.

To develop revenue for the wildlife habitat, the land banking company first determines appropriate investment instruments for the endowment. (Step 1C.) Pursuant to the present invention, the appropriate instruments are those offered by the sponsoring government, assuming those instruments are available, secure and appropriate for mitigation purposes. For example, if the infrastructure project is ftunded by the United States Department of Transportation (the “originating government agency” or “originating agency” for the purposes of this example only), the endowment is invested in suitable financial instruments offered by the United States of America (the “sponsoring government” for the purposes of this example only). On the other hand, if the project is funded by the California Department of Transportation, the endowment is invested in suitable financial instruments offered by the State of California. If the project is funded in corroboration by both federal and state government agencies, the endowment may be invested in the financial instruments of one government or another, or both, in either proportionate or non-proportionate shares. Whether an instrument is secure, appropriate and/or stable may be determined by any number of methods, such as, but not limited to, reviewing popular market indexes for government-offered financial instruments.

Investing the endowment in the financial instruments of the sponsoring government causes the endowment to be returned to that government's general treasury. (Step 1D.) This essentially “recycles” the endowment principal and results in a zero net loss to the sponsoring government—the endowment amount is simply transferred from the originating government agency's infrastructure budget to the sponsoring government's general treasury by way of the land banking company's investments. Such recycling allows the sponsoring government to utilize the endowment amount for any number of other purposes, including the funding of additional infrastructure projects.

If the sponsoring government does not offer financial instruments, the endowment may be invested in other available, secure and appropriate financial instruments. For example, if the mitigable infrastructure project is sponsored by a municipal government (particularly, one that does not offer financial instruments), the appropriate financial instruments may be those offered by the state government, since monies from the state treasury may be spent upon state and local public infrastructure projects, or other projects potentially benefiting the municipality. Alternatively, the endowment may be invested in federal and/or private financial instruments, depending upon the income needs of the habitat.

The land banking company, as the holder of the financial instruments, receives the interest and profits earned by those instruments. (Step 1E.) Such income is used to develop the wildlife habitat and pay its annual expenses. (Step 1F.) To develop the habitat, the land banking company locates one or more suitable parcels of real property as sites for the wildlife habitat. The company will usually obtain an easement over the real property, either long-term or for perpetuity, in exchange for rents and/or tax incentives. The process of obtaining the easement may occur prior to the first-year return upon the investments, or as depicted herein, after the first-year income has been received. The latter is preferable, but not required, over the former, since this allows the land banking company to obtaining the easement with interest income, rather than invading the endowment itself. Alternatively, the company may lease the property itself, either long-term or for perpetuity, or purchase the property outright from the owner.

The annual expenses may include, among other things: further development of the habitat, including the purchase of natural resources to create or maintain certain conditions or improvements, such as bodies of water, marshlands or nesting grounds; rental, installment, maintenance, operating and/or utility expenses for various equipment; administration fees and salaries; rental payments to the landowner for use of the land; property taxes, if applicable; and licensing fees for use of the present invention. (Steps 1G-1I.)

Because the expenses are paid from the investment income, the present invention significantly reduces the risk of the habitat becoming abandoned or de-funded due to depletion of the endowment. In the event of emergencies or unanticipated expenses (such as natural disasters or environmental damage requiring extensive repairs to the habitat), the endowment may be invaded. However, any invasion of the endowment should be as minimal as possible, and temporary.

Furthermore, the priority of paying the expenses may be structured so as to further safeguard the endowment. For example, the administration fees and salaries may be paid last. This means that the land banking company's fees would be reduced accordingly if the wildlife habitat is managed poorly, thereby providing an additional incentive for the company to work effectively.

On the other hand, if the income exceeds the habitat's expenses, the land banking company may allocate the remaining income in any number of ways. For example, the company may elect to do one or more of the following, in any order: replenish an invaded endowment and/or increase the habitat's endowment in anticipation of future emergencies; distribute the remaining income to the landowner and/or habitat administrators; or fund additional projects designated by the administrators and/or sponsoring government, such as improvements to the existing habitat, alternative habitats for the same or other species, and/or other projects entirely. However, it is apparent that any invasion of the endowment should be replenished immediately so as not to adversely affect future income. Furthermore, given the potential gradual increase of annual expenses over time (discussed in greater detail below), a portion of any remaining income should be set aside for additional investments.

Upon maturity of the financial instruments, the endowment principal is “rolled over” or invested in the same, similar, or other suitable instruments offered by the sponsoring government. This ensures that the sponsoring government is never deprived of the endowment amount. Thus, the only money ever removed from the sponsoring government's treasury is the interest and/or profits it pays to the land banking company as holder of the financial instruments. This is the same money that the sponsoring government would pay to any other holder of a government-offered financial instrument.

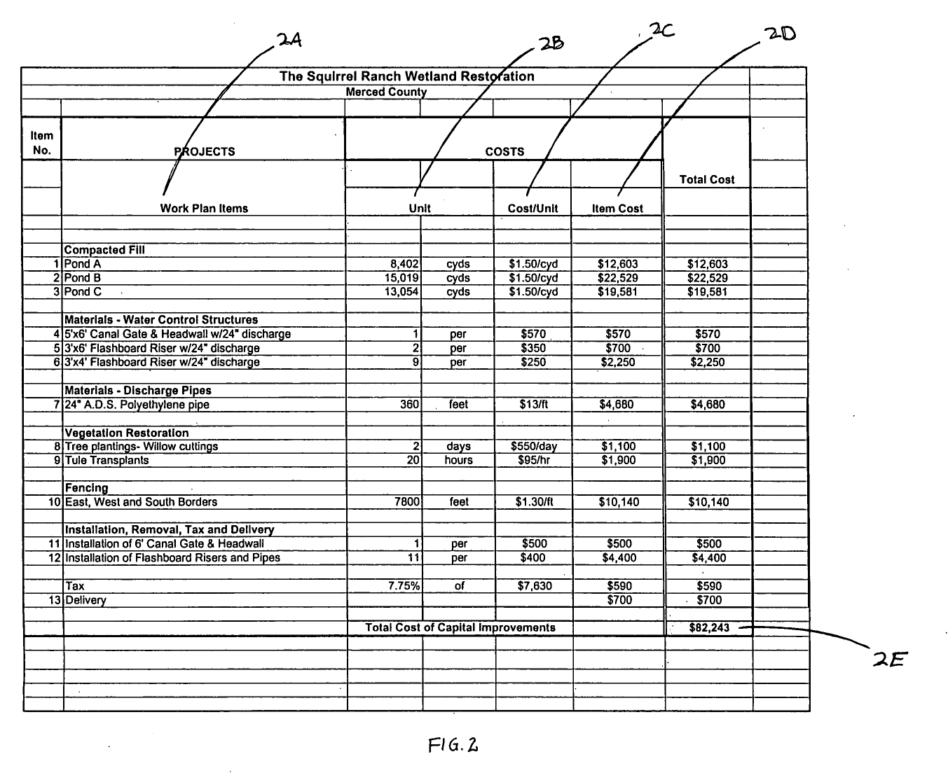

FIG. 2 depicts certain startup costs for a wetland restoration project. The various items of capital improvement are described in column 2A. The units of labor and/or materials, the cost per unit, and the subtotal for each item of improvement are listed in columns 2B through 2D, respectively. As depicted in cell 2E, the total cost of the capital improvements is $82,243.00.

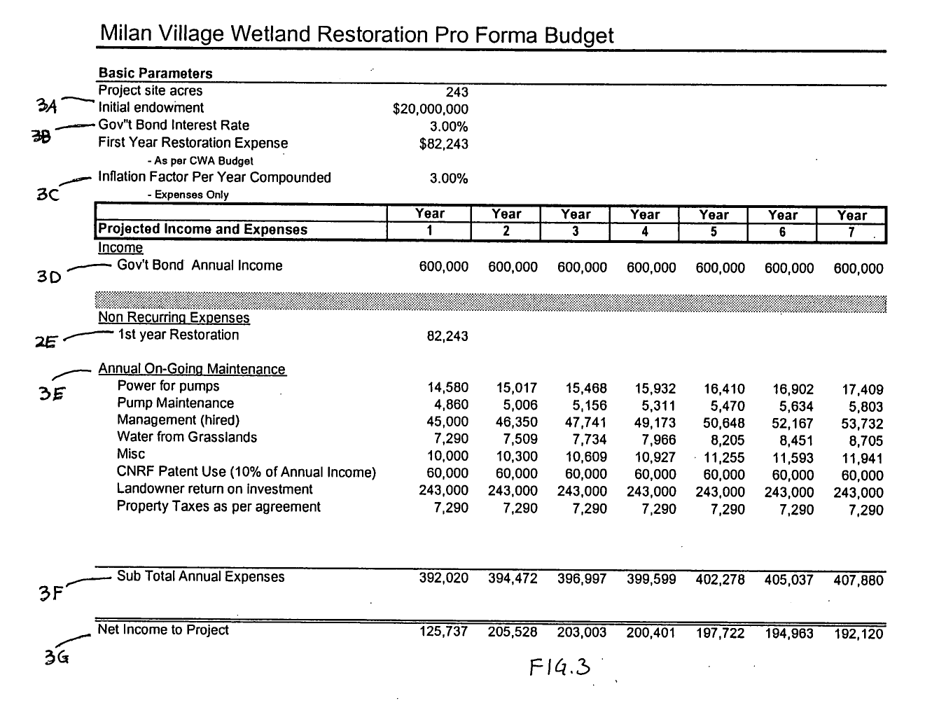

FIG. 3 depicts a pro form a budget for a wetland restoration project developed and administered according to the present invention. As depicted therein, the initial endowment amount 3A set aside from the infrastructure project contract price (Step 1B) is twenty million dollars ($20,000,000.00). The endowment is invested in financial instruments of the sponsoring government (Step 1C) bearing an interest rate 3B of three percent (3.00%) per annum. The land banking company receives, as income 3D, the interest and/or profits earned from such investments (Step 1E), in the amount of six hundred thousand dollars ($600,000.00) per annum. For purposes of this example, it will be assumed that such income is fixed for perpetuity.

After receiving the first-year income from its investments, the land banking company develops (Step 1F) the wildlife habitat. The one-time cost for such capital improvements 2E, in the amount of $82,243.00, is paid from the first-year income.

Additional recurring annual expenses 3E/Year-One are also paid (Steps 1G-1I) from the first-year income—for the purposes of this example, the total of such annual expenses 3F/Year-One is $392,020.00. After deducting all of the first-year expenses, the remaining income 3G/Year-One from the investments is $125,737.00. Such remainder may be used for any of the purposes previously described herein.

For subsequent years of operation, it will be assumed for purposes of this example that certain expenses bear a compounded inflation factor 3C of three percent (3.00%) per annum. (See 3G, Years Two through Seven.) This may result from any one or more of the following: depreciation and/or replacement of habitat equipment; habitat maintenance and restoration expenses; increases in administration salaries or fees; or any number of other reasons. Thus, while the income 3D from the investments continue to exceed the habitat's annual expenses 3E for each of the first seven years, it is apparent that the habitat's annual expenses 3E will eventually equal, and exceed, the investment income 3D if the latter is not increased. Thus, at least a portion of the net income 3G for each year should be re-invested in appropriate financial instruments to prevent eventual invasion of the endowment.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

For example, the present invention is not limited to public infrastructure projects. The methods disclosed herein are equally applicable to community improvement projects, public housing developments or business relocation incentive programs. The present invention may also be used for many other forms of contractual relationship, either between private or public entities, or combinations thereof.

The present invention may also be used for projects having finite durations. For example, a land banking company (or a similarly situated company if the purpose is something other than an infrastructure project) may be permitted to invade a predefined portion of the endowment for each year of operation. The particular extent of invasion would be calculated to fully deplete the endowment by the project termination date, while taking into consideration all recurring expenses throughout the project lifetime and maintaining an adequate reserve so that the endowment is not depleted beforehand.

Finally, as discussed above, there may insufficient government-offered financial instruments available for investment, in which case a portion of the endowment would be invested whatever suitable government-offered financial instruments exist, while the remaining endowment is invested in suitable public or private financial instruments.

1. A method of administering project funding, comprising the steps of:
a. receiving an endowment from an entity;
b. utilizing said endowment to purchase financial instruments offered by said entity;
c. receiving income generated by said instruments; and
d. utilizing said income to pay project expenses.

2. The method of claim 1, comprising the additional step of invading said endowment only under certain predefined circumstances.

3. The method of claim 2, comprising the additional step of replenishing said invasion of said endowment from subsequent income earned from said investments.

4. The method of claim 1, wherein said purchase of said instruments offered by said entity results in no net loss of finds for said entity.

5. The method of claim 1, wherein, upon maturity of said financial instruments, said endowment is used to purchase additional financial instruments offered by said entity.

6. The method of claim 1, wherein said project funding terminates pursuant to a predetermined duration.

7. The method of claim 6, wherein the endowment is invaded pursuant to a predetermined schedule.

8. The method of claim 7, wherein such invasion causes said endowment to be depleted upon a project termination date.

9. A method for administering a real estate mitigation endowment project, comprising the steps of:
a. receiving a mitigation endowment from a government entity;
b. utilizing said mitigation endowment to purchase financial instruments offered by a government entity;
c. receiving income generated by said instruments; and
d. utilizing said income to pay the expenses of the real estate mitigation project.

10. The method of claim 9, comprising the additional step of allowing invasion of said mitigation endowment only under certain predefined circumstances.

11. The method of claim 10, comprising the additional step of replenishing said invasion of said mitigation endowment from subsequent income earned from said instruments.

12. The method of claim 9, wherein said purchase of said instruments offered by said government entity results in no net loss of funds for said entity.

13. The method of claim 9, wherein, upon maturity of said financial instruments, said endowment is used to purchase additional financial instruments offered by a government entity.

14. The method of claim 9, wherein said mitigation project finding terminates pursuant to a predetermined duration.

15. The method of claim 14, wherein the mitigation endowment is invaded pursuant to a predetermined schedule.

16. The method of claim 15, wherein such invasion causes said mitigation endowment to be depleted upon a project termination date.

17. A method for administering a real estate mitigation endowment, comprising the steps of:
a. receiving a mitigation endowment from a public entity;
b. utilizing said mitigation endowment to purchase financial instruments offered by a public entity, such that said government entity suffers no net loss of funds;
c. receiving income generated by said instruments;
d. utilizing said income to pay the expenses of the mitigation project;
e. allowing invasion of said mitigation endowment only under certain predefined circumstances;
f. replenishing said invasion of said mitigation endowment from subsequent income earned from said instruments;
g. upon maturity of said instruments, utilizing the endowment to purchase additional financial instruments offered by a public entity.

18. The method of claim 17, wherein said mitigation project funding terminates pursuant to a predetermined duration.

19. The method of claim 18, wherein the mitigation endowment is invaded pursuant to a predetermined schedule.

20. The method of claim 19, wherein such invasion causes said mitigation endowment to be depleted upon a project termination date.

21. A method of administering project funding, wherein an endowment received from a public entity has been utilized to purchase financial instruments offered by a public entity, comprising the steps of:
a. receiving income generated by said financial instruments; and
b. utilizing said income to pay project expenses.

22. The method of claim 21, comprising the additional step of allowing invasion of said endowment only under certain predefined circumstances.

23. The method of claim 22, comprising the additional step of replenishing said invasion of said endowment from subsequent income earned from said instruments.

24. The method of claim 21, comprising the additional step of purchasing additional financial instruments offered by a public entity.

25. The method of claim 21, wherein said mitigation project funding terminates pursuant to a predetermined duration.

26. The method of claim 25, wherein the endowment is invaded pursuant to a predetermined schedule.

27. The method of claim 26, wherein such invasion causes said endowment to be depleted by a predetermined date.

28. The method of claim 21, comprising the additional step of determining other uses for said income pursuant to a set of predetermined criteria.

29. The method of claim 28, comprising the additional step of utilizing at least a portion of said income for said other uses.

30. A method of administering a mitigation endowment project, wherein an endowment received from a government entity has been utilized to purchase financial instruments offered by an entity, comprising the steps of:
a. receiving income generated by said financial instruments;
b. utilizing said income to pay project expenses;
c. allowing invasion of said mitigation endowment only under certain predefined circumstances;
d. replenishing said invasion of said mitigation endowment from subsequent income earned from said instruments; and
e. upon maturity of said instruments, utilizing the endowment to purchase additional financial instruments offered by a public entity.

31. The method of claim 30, wherein said mitigation project funding terminates pursuant to a predetermined duration.

32. The method of claim 31, wherein the endowment is invaded pursuant to a predetermined schedule.

33. The method of claim 32, wherein such invasion causes said endowment to be depleted by a predetermined date.

34. The method of claim 30, comprising the additional step of determining other uses for said income pursuant to a set of predetermined criteria.

35. The method of claim 34, comprising the additional step of utilizing at least a portion of said income for said other uses.

36. The method of claim 30, wherein said entity from whom the financial instruments are purchased is the same entity as the entity from whom the mitigation endowment is received.

37. The method of claim 30, wherein said entity from whom the financial instruments are purchased is a different entity from the entity from whom the mitigation endowment is received.

38. The method of claim 37, wherein said entity from whom the financial instruments are purchased is another government entity.

39. The method of claim 37, wherein said entity from whom the financial instruments are purchased is a private entity.
